(19) United States
(12) Patent Application Publication
(10) Pub. No.: US 2023/0104696 A1
(43) Pub. Date: Apr. 6, 2023

(54) INFORMATION REGISTRATION DEVICE, INFORMATION REGISTRATION SYSTEM, INFORMATION REGISTRATION METHOD AND PROGRAM STORAGE MEDIUM

(71) Applicant: NEC Corporation, Minato-ku, Tokyo (JP)

(72) Inventor: Yifeng ZHOU, Tokyo (JP)

(73) Assignee: NEC Corporation, Minato-ku, Tokyo (JP)

(21) Appl. No.: 17/909,600

(22) PCT Filed: Mar. 2, 2021
(86) PCT No.: PCT/JP2021/007960

§ 371 Date: Sep. 6, 2022

(30) Foreign Application Priority Data
Mar. 30, 2020 (JP) 2020-059322

(51) Int. Cl. G06T 7/70; G06T 7/30; H04N 7/18

(52) U.S. Cl. CPC G06T 7/70; G06T 7/30; H04N 7/183; G06T 2207/10016; G06T 2207/30232; G06T 2207/30201

(57) ABSTRACT

In order to shorten the operation time for a registration operator to make a designation to register a subregion where a person or thing to be registered appears in a captured image, this information registration device is provided with a line-of-sight detection unit, an extraction unit and a registration unit. The line-of-sight detection unit detects the line of sight of the registration operator who is looking at the captured image which is shown on a display device. If the registration operator's detected line of sight has not moved for an attention time configured in advance, the extraction unit extracts an image of the person or object appearing in the subregion of the captured image where the registration operator's line of sight is directed. The registration unit registers the extracted image in a predetermined storage device.

### TECHNICAL FIELD

The present invention relates to a technique for registering an image of a person or an object to be registered.

### BACKGROUND ART

In a monitoring system using a video camera, there is a technique in which, when a surveillance staff member finds a person who is considered as a suspicious person from a monitoring video of the video camera, the surveillance staff member designates the person on the monitoring video, and a computer of the system tracks the designated person on the monitoring video. As a technique in which a surveillance staff member designates a person considered to be a suspicious person on a monitoring video, for example, PTL 1 discloses a technique in which a surveillance staff member (operator) designates a suspicious person on a monitoring video using an input device such as a mouse.

PTL 2 discloses a technique for controlling the direction of a monitoring camera using position information of a mobile terminal possessed by a security guard or the like.

### CITATION LIST

### Patent Literature

[PTL 1] JP 2005-110100 A
[PTL 2] WO 2016/147581 A

### SUMMARY OF INVENTION

### Technical Problem

In the technique disclosed in PTL 1, since the surveillance staff member designates a suspicious person (in other words, a person to be tracked) in the monitoring video using the input device, the following problem occurs when a large number of people gather at the same time in the monitoring area, for example, in a stadium or an event venue. That is, there is a problem that it is difficult to register all the persons to be tracked using the input device in a case where the number of persons who is required to be simultaneously monitored by one surveillance staff member is large and there is a plurality of persons who is required to be registered as the persons to be tracked in a short time.

More specifically, for example, it is assumed that the number A of persons simultaneously appearing in the monitoring video is 10 (A=10), and the average value B of the display time per person until the person who starts appearing in the monitoring video moves and goes out of the monitoring video is 10 seconds (B=10). The time C required for the surveillance staff member to determine whether the person appearing in the monitoring video is a suspicious person is about 0.5 seconds (C=0.5). Furthermore, the time required for determining whether to register the detected suspicious person as the person to be tracked is about 0.2 seconds (D=0.2). As a result, the time F required for the surveillance staff member to determine whether the 10 people appearing in the monitoring video are suspicious persons and determine whether to register as the person to be tracked is calculated as 10×(0.5+0.2)=7 seconds by the formula F=A×(C+D).

Here, as described above, the average value B of the display time per person is 10 seconds (B=10). Therefore, the time H that can be used for the registration of the person to be tracked after determining whether each person in the monitoring video in which 10 persons appear is a suspicious person and determining whether to register the person is 10−7=3 seconds according to the formula H=B−F.

On the other hand, the time E required for the operation in which the surveillance staff member registers one person to be tracked on the monitoring video using the input device after determining to register the one person is about 3 seconds (E=3). That is, the time H that can be used for registering the person to be tracked by determining whether each person in the monitoring video in which 10 persons appear is a suspicious person and determining whether to register the person is 3 seconds as described above, which is approximately the same as the time E required for the operation of registering one person to be tracked. Therefore, when there is only one person to be tracked, the surveillance staff member can register the person to be tracked using the input device. However, when there is a plurality of persons to be tracked, the surveillance staff member cannot register the plurality of persons to be tracked on the monitoring video.

The present invention has been devised in order to solve the above-described problems. That is, a main object of the present invention is to provide a technique for reducing an operation time for a registered operator to designate for registration a partial region in which a person or an object to be registered is projected in a captured image.

### Solution to Problem

In order to achieve the object described above, according to an aspect of the present invention, an information registration device includes a line-of-sight detection unit that detects a line-of-sight of a registered operator who is a person viewing a captured image in which a person or an object to be possibly registered is captured, an extraction unit that extracts an image of the person or the object appearing in a partial region of the captured image ahead of the detected line-of-sight in a case where the detected line-of-sight has not moved for a preset attention time, and a registration unit that registers the extracted image in a predetermined storage device.

According to an aspect of the present invention, an information registration system includes the information registration device described above, a display device that displays the captured image in which a person or an object to be possibly registered is captured, and a line-of-sight information providing device that provides the information registration device with information for detecting a line-of-sight of the registered operator who is a person viewing the captured image.

According to an aspect of the present invention, an information registration method includes detecting a line-of-sight of a registered operator who is a person viewing a captured image in which a person or an object to be possibly registered is captured, extracting an image of the person or the object appearing in a partial region of the captured image ahead of the detected line-of-sight in a case where the detected line-of-sight has not moved for a preset attention time, and registering the extracted image in a predetermined storage device.

According to an aspect of the present invention, a program storage medium stores a computer program for causing a computer to execute a process of detecting a line-of-sight of a registered operator who is a person viewing a captured image in which a person or an object to be possibly registered is captured, a process of extracting an image of the person or the object appearing in a partial region of the captured image ahead of the detected line-of-sight in a case where the detected line-of-sight has not moved for a preset attention time, and a process of registering the extracted image in a predetermined storage device.

### Advantageous Effects of Invention

According to the present invention, it is possible to shorten an operation time for a registered operator designates for registration a partial region where a person or an object to be registered is projected in a captured image.

### BRIEF DESCRIPTION OF DRAWINGS

FIG. 1 is a diagram illustrating a configuration of an information registration system according to a first example embodiment of the present invention.

FIG. 2 is a block diagram illustrating a functional configuration of an information registration device constituting the information registration system according to the first example embodiment.

FIG. 3 is a view illustrating an example of one aspect of a registration button.

FIG. 4 is a diagram illustrating an example of a process of confirming an image to be registered.

FIG. 5 is a diagram illustrating another example of a process of confirming an image to be registered.

FIG. 6 is a flowchart illustrating an operation example of the information registration device according to the first example embodiment.

FIG. 7 is a diagram illustrating a configuration of an information registration system according to a second example embodiment of the present invention.

FIG. 8 is a diagram illustrating a configuration of an information registration system according to a third example embodiment of the present invention.

FIG. 9 is a diagram for explaining a mobile terminal used by a registered operator in the third example embodiment.

FIG. 10 is a block diagram illustrating a functional configuration of an information registration device constituting an information registration system according to the third example embodiment.

FIG. 11 is a diagram illustrating a configuration of an information registration system according to a fourth example embodiment of the present invention.

FIG. 12 is a block diagram illustrating a functional configuration of an information registration device according to the fourth example embodiment.

FIG. 13 is a flowchart illustrating an operation example of the information registration device according to the fourth example embodiment.

### EXAMPLE EMBODIMENT

Hereinafter, an example embodiment according to the present invention will be described with reference to the drawings.

### First Example Embodiment

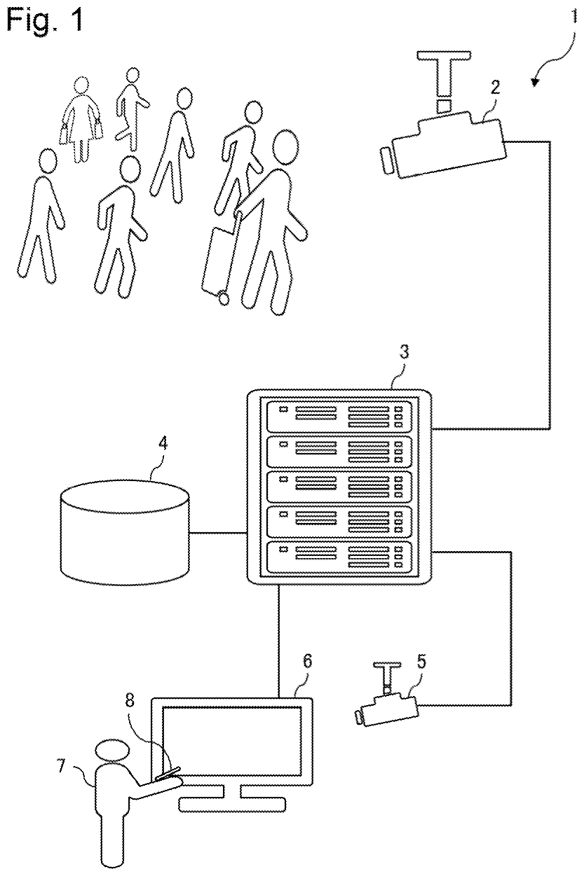

FIG. 1 schematically illustrates a configuration of an information registration system according to the first example embodiment of the present invention. An information registration system 1 of the first example embodiment is a system incorporated in a monitoring system using an image (also referred to as a monitoring video) captured by a monitoring camera. The information registration system 1 is a system that, in a case where a surveillance staff member who monitors a monitoring video detects a person who is considered as a suspicious person from a captured image, shortens the time required for an operation in which a surveillance staff member registers an image of the detected person.

That is, the information registration system 1 of the first example embodiment includes an imaging device 2, an information registration device 3, a database 4, an imaging device 5, a display device 6, and an input device 8.

The imaging device 2 is a device that captures an image of an area monitored by the monitoring system, and is, for example, a video camera. In the example of FIG. 1, only one such imaging device 2 for monitoring is illustrated, but there is a case where there is a plurality of imaging devices 2 for monitoring used by the monitoring system. In this case, the information registration system 1 of the first example embodiment also includes the plurality of imaging devices 2.

The imaging device 2 is connected to the information registration device 3 and has a function of outputting a monitoring video that is a captured image to the information registration device 3 from moment to moment. The monitoring video output from the imaging device 2 to the information registration device 3 is associated with time information indicating an imaging time and location information indicating an imaging location. Examples of the location information indicating the imaging location include identification information for identifying the imaging device 2 and identification information for identifying the monitoring area imaged by the imaging device 2. In a case where the identification information for identifying the imaging device 2 is used as the location information, for example, data in which the identification information of the imaging device 2 is associated with information about the location where the imaging device 2 having the identification information is installed is held in the information registration device 3.

The database 4 is a storage device that stores data. In the first example embodiment, for example, an image of a person determined to be a suspicious person or the like used by a monitoring system in which the information registration system 1 is incorporated is stored as a reference image.

The display device 6 is a device that displays video, characters, and the like, and in the first example embodiment, the display operation is controlled by the information registration device 3. The display device 6 displays the monitoring video captured by the imaging device 2 by the control operation of the information registration device 3. The monitoring video displayed by the display device 6 is used when a surveillance staff member 7 monitors the area to be monitored.

The input device 8 is a device operated by the surveillance staff member 7 to input information to the information registration device 3. The input device 8 may be a device dedicated to information input including a mechanical push button or the like, or may be a mobile terminal having an information processing function including an arithmetic device and a display device, and an aspect thereof is not limited herein.

The imaging device 5 is an imaging device installed in such a way as to image at least the face of the surveillance staff member 7 viewing the monitoring video displayed by the display device 6. In other words, the imaging device 5 is installed in such a way as to be able to video to detect the face and the line-of-sight of the surveillance staff member 7 viewing the monitoring video by the display device 6. For example, in a case where the surveillance staff member 7 sits on a chair and monitors the monitoring video of the display device 6, the imaging device 5 is installed at a position where the surveillance staff member 7 and the display device 6 can be imaged in such a way that the positional relationship between the position of the eyes of the surveillance staff member 7 sitting on the chair and the display screen of the display device 6 can be understood. Alternatively, the imaging device 5 may be attached to the display device 6 in such a way as to be able to image the eyes of the surveillance staff member 7 viewing the monitoring video of the display device 6. That is, the imaging device 5 functions as a line-of-sight information providing device.

The imaging device 5 is connected to the information registration device 3, and outputs captured images to the information registration device 3 from moment to moment. Time information indicating an imaging time is associated with the image, captured by the imaging device 5, output to the information registration device 3.

The monitoring system in which the information registration system 1 of the first example embodiment is incorporated has a function of tracking a person or an object that the surveillance staff member 7 feels suspicious in the monitoring video when the person or the object that the surveillance staff member 7 feels suspicious exists in the monitoring video.

Information about a reference image of a suspicious person or a suspicious object necessary for the tracking process is designated in the monitoring video by the surveillance staff member 7 and registered in the database 4. That is, in the first example embodiment, the surveillance staff member 7 is also a registered operator who registers information.

The information registration device 3 is a device that executes a process of registering information about the reference image used in the tracking process of such a monitoring system in the database 4. The information registration device 3 includes a computer device (server). The computer device may be a computer device that executes a process of a monitoring system in which the information registration system 1 of the first example embodiment is incorporated, or may be a device separate from the computer device of the monitoring system.

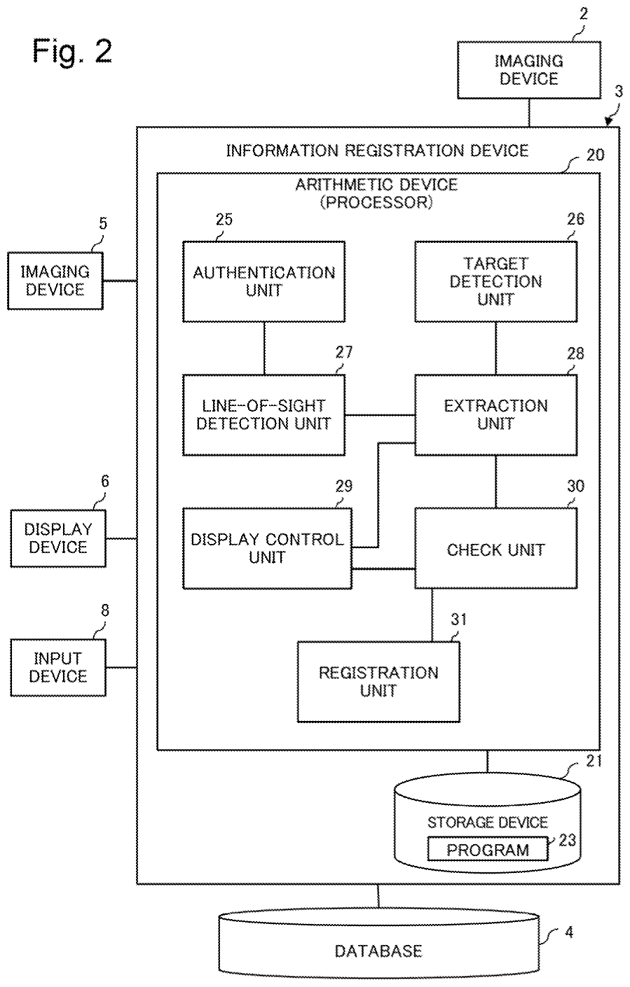

FIG. 2 is a block diagram illustrating a functional configuration of the information registration device 3. The information registration device 3 includes an arithmetic device 20 and a storage device 21. The storage device 21 is a storage medium that stores data and a computer program (hereinafter, also referred to as a program) 23. There are various types of storage media, and the storage device 21 may include any storage medium. The information registration device 3 may include a plurality of types of storage media, and in this case, the plurality of types of storage media is collectively represented as the storage device 21. Description of the configuration and operation of the storage device 21 will be omitted.

The arithmetic device 20 includes, for example, a processor such as a central processing unit (CPU) or a graphics processing unit (GPU). The processor can have various functions based on the program by reading and executing the program stored in the storage device 21. For example, in the first example embodiment, the arithmetic device 20 includes function units such as an authentication unit 25, a target detection unit 26, a line-of-sight detection unit 27, an extraction unit 28, a display control unit 29, a check unit 30, and a registration unit 31.

The display control unit 29 has a function of controlling a display operation of the display device 6. By the control operation of the display control unit 29, the monitoring video received from the imaging device 2 is displayed on the display device 6 in substantially the rear time, and the presentation information to the surveillance staff member 7 by the information registration device 3 is displayed on the display device 6. In a case where the information registration system 1 includes a plurality of imaging devices 2, the display control unit 29 controls the display operation of the display device 6 such that the monitoring videos by the imaging devices 2 are displayed side by side on one screen, or the display is switched and displayed in order.

Meanwhile, in the first example embodiment, the information registration device 3 has a function of limiting the surveillance staff member 7 who can register reference images using the information registration device 3. That is, the face image (hereinafter, also referred to as an authorized face image) of the surveillance staff member 7 permitted to register the reference image is registered in advance in the database 4, the storage device 21 of the information registration device 3, or a storage device (not illustrated) separate from the database 4 and the storage device 21.

When acquiring the face image (hereinafter, also referred to as a captured face image) of the surveillance staff member 7 captured by the imaging device 5, the authentication unit 25 has a function of collating the captured face image with a previously-registered authorized face image and determining whether the face images match each other. The authentication unit 25 has a function of outputting permission information indicating that the surveillance staff member 7 related to the captured face image, that is, the surveillance staff member 7 captured by the imaging device 5 is a person who is permitted to register a reference image in a case where there is an authorized face image matching the captured face image. Such an authentication process by the authentication unit 25 is executed at every preset timing.

The target detection unit 26 has a function of detecting an image of a face as an image of a person to be possibly registered from all frame images of a monitoring video received from the imaging device 2 or frame images selected for every preset number interval in a case where the frame images are disposed in time series. The target detection unit 26 has a function of assigning identification information to each detected face image and generating face position information by associating the identification information with the identification information of the detected frame image and information indicating a partial region of the detected image in the detected frame image. Furthermore, the target detection unit 26 registers such face position information in the database 4 or a storage device (not illustrated) separate from the database 4. As a method of detecting a face from a monitoring video, there are various methods such as a method of using pattern matching using a basic pattern of a face, and here, an appropriate method in consideration of processing capability of the information registration device 3 and the like is used, and the description thereof will be omitted.

In the first example embodiment, the target detection unit 26 has a function of detecting not only a face but also a predetermined object (for example, an object (wand, hat, sunglasses, etc.) possessed or worn by a person, a moving object such as a car, or the like) to be possibly registered. Furthermore, the target detection unit 26 has a function of generating object position information similar to the face position information and registering the object position information in the database 4 or a storage device (not illustrated) separate from the database 4.

The line-of-sight detection unit 27 has a function of detecting a direction (that is, the line-of-sight) in which the eyes are directed in the captured face image captured by the imaging device 5. A method of detecting the line-of-sight is not limited, but for example, there is a method of detecting the line-of-sight by detecting the center position of the iris in the white portion from the captured face image.

The line-of-sight detection unit 27 has a function of detecting that the detected line-of-sight has not moved for a preset attention time (for example, 0.5 seconds). Specifically, in a case where the detected line-of-sight does not deviate from a preset allowable range for determining whether the line-of-sight has not moved over a plurality of frame images captured at the attention time, the line-of-sight detection unit 27 detects that the line-of-sight has not moved.

In the first example embodiment, the process by the line-of-sight detection unit 27 is executed only on the face image of the surveillance staff member 7 for which the permission information has been output by the authentication unit 25.

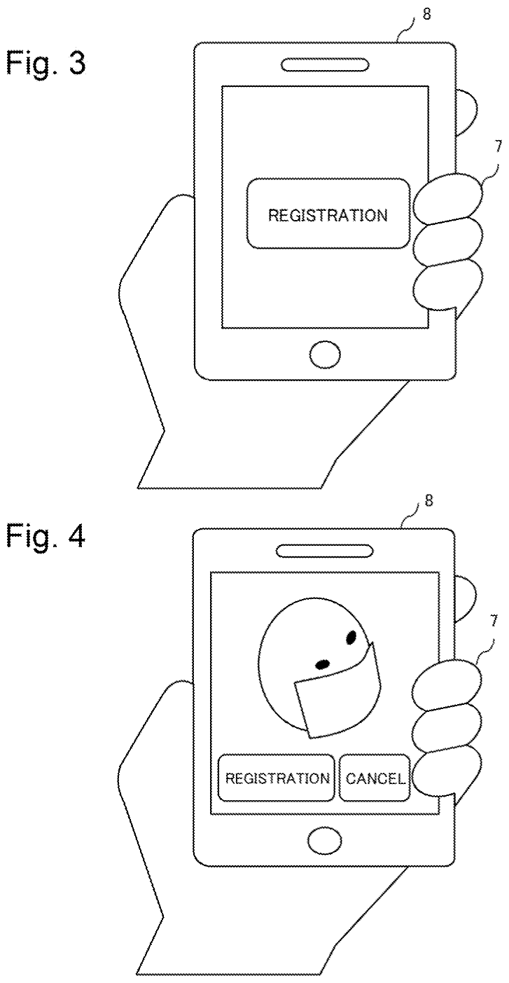

In the case of the line-of-sight detection unit 27, the extraction unit 28 determines whether the registration button (a mechanical push button, an icon displayed on a screen, or the like) of the input device 8 as illustrated in FIG. 3 has been operated during the period in which the line-of-sight has not moved. In a case where the registration button is operated and the registration command is received from input device 8, the extraction unit 28 executes the following processing. For example, the extraction unit 28 detects a partial region of the display screen of the display device 6 ahead of the line-of-sight by using information indicating a direction from the surveillance staff member (registered operator) viewing the monitoring video of the display device 6 toward the display screen of the display device 6 and a range thereof and information indicating a direction toward which the line-of-sight detected by the line-of-sight detection unit 27 is directed. The information indicating the partial region of the display screen ahead of the detected line-of-sight is associated with the time information same as the time information associated with the frame image displayed on the display device 6 at the timing when the detection processing is executed (the timing when the registration command is received).

Further, the extraction unit 28 acquires the face position information or the object position information generated by the target detection unit 26 in the frame image of the monitoring video captured by the imaging device 2 at the same time by using the time information associated with the information indicating the partial region of the display screen ahead of the detected line-of-sight. Then, in a case where there is face position information or object position information related to a partial region of the display screen of the display device 6 ahead of the line-of-sight of the surveillance staff member 7, the extraction unit 28 extracts an image of a partial region of a frame image related to the face position information or the object position information from the frame image as registration information.

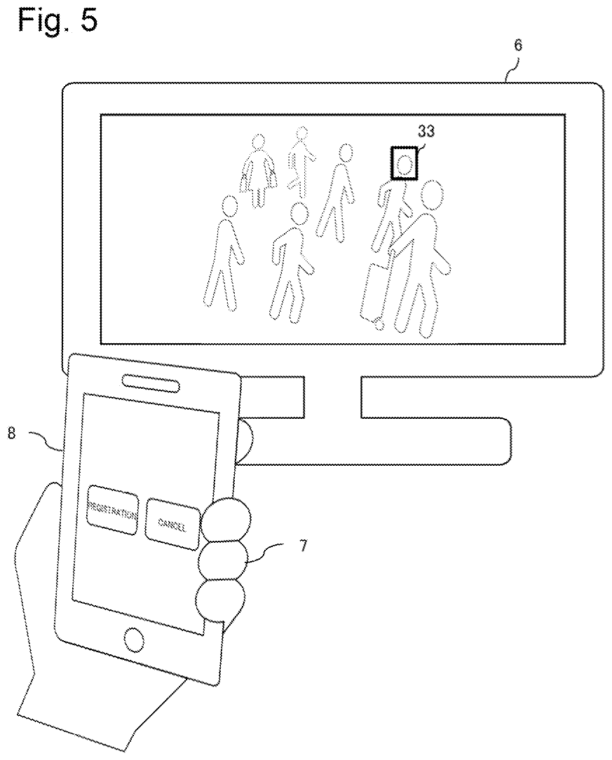

The check unit 30 has a function of executing a process of checking with the surveillance staff member (that is, the registered operator) 7 whether the image extracted by the extraction unit 28 may be confirmed as the registration information. For example, the check unit 30 presents the image of the partial region of the frame image extracted by the extraction unit 28 to the surveillance staff member 7, and executes a process of causing the input device 8 to input a determination result as to whether the presented image is confirmed as the registration information from to the information registration device 3. A method of presenting the image of the partial region of the frame image extracted by the extraction unit 28 to the surveillance staff member 7 includes the following method. For example, in a case where the input device 8 is a mobile terminal including a display device, the check unit 30 transmits the extracted image to the input device 8. Upon receiving the extracted image, the input device 8 presents the image to the surveillance staff member 7 by displaying the image of the partial region of the frame image extracted by the extraction unit 28 on the display screen of the display device as illustrated in FIG. 4. Alternatively, as illustrated in FIG. 5, the check unit 30 causes the display control unit 29 to display a frame 33 representing a partial region of the frame image extracted by the extraction unit 28 on the display screen of the display device 6 displaying the monitoring video. In this manner, the image of the partial region of the frame image extracted by the extraction unit 28 may be presented to the surveillance staff member 7.

On the other hand, when the registration button (a mechanical push button, an icon displayed on a screen, or the like) of the input device 8 as illustrated in FIG. 4 is operated, a confirmation command is output from the input device 8 into the information registration device 3. When a cancel button (a mechanical push button, an icon displayed on a screen, or the like) of the input device 8 is operated, a cancel command is output from the input device 8 into the information registration device 3. In a case where the check unit 30 receives the confirmation command from the input device 8 before a predetermined confirmation period elapses after the image of the partial region of the extracted frame image is presented, the check unit confirms the image of the partial region of the extracted frame image as the registration information. In a case where the check unit 30 receives the cancel command from the input device 8 during the confirmation period, or in a case where neither the confirmation command nor the cancel command is received even after the lapse of the confirmation period, the check unit cancels the image of the partial region of the extracted frame image.

In a case where the registration information is received from the input device 8 by the process of the check unit 30, the registration unit 31 has a function of registering the image of the partial region of the frame image extracted by the extraction unit 28 in the database 4 as the registration information. The same information as that assigned by the target detection unit 26 is continuously associated with the image registered in the database 4. In the monitoring system in which the information registration system 1 of the first example embodiment is incorporated, for example, the tracking process is executed using the information of the image registered in the database 4.

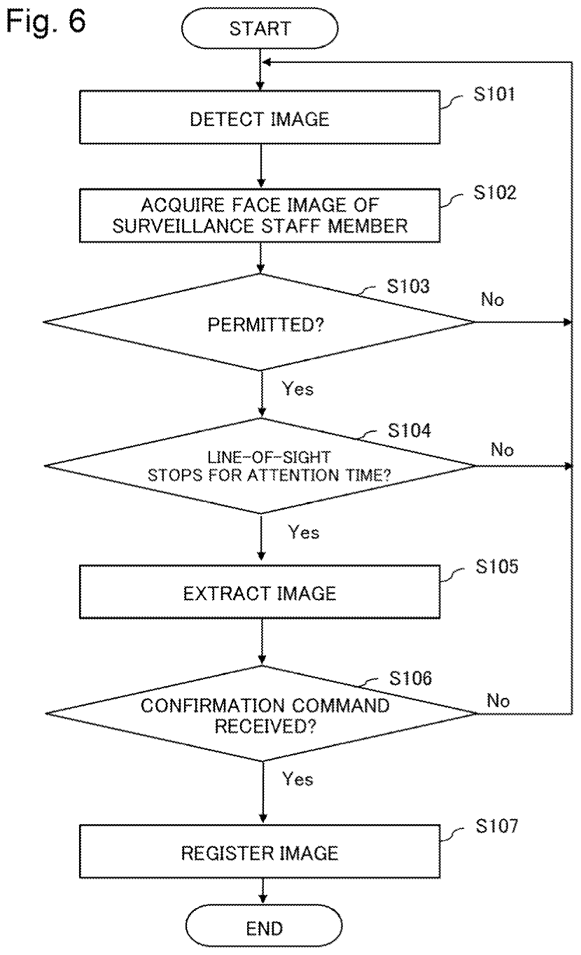

The information registration system 1 and the information registration device 3 according to the first example embodiment are configured as described above. Next, an operation example related to information registration of the information registration device 3 will be described with reference to FIG. 6. For example, when the information registration device 3 receives the monitoring video of the imaging device 2, the target detection unit 26 detects an image of a predetermined person's face or a predetermined object to be possibly registered from the monitoring video (step S101).

On the other hand, when the information registration device 3 receives the captured image from the imaging device 5, and the authentication unit 25 acquires the captured face image of the surveillance staff member 7 by the imaging device 5 (step S102), the captured face image is collated with the authorized face image. Then, the authentication unit 25 determines whether there is an authorized face image that matches the captured face image. That is, the authentication unit 25 determines whether the surveillance staff member 7 of the captured face image is a person who is permitted to register information (step S103). In a case where it is not permitted, the information registration device 3 repeats the operations in and after step S 101.

After the permission is confirmed, the line-of-sight detection unit 27 detects the line-of-sight from the captured face image by the imaging device 5, and determines whether the line-of-sight has not moved for the attention time (step S104). In a case where the line-of-sight moves before the time exceeds the attention time, the information registration device 3 repeats the operations in and after step 5101.

In a case where the line-of-sight does not move for the attention time, the extraction unit 28 extracts an image of a partial region of the display screen ahead of the line-of-sight from the monitoring video after confirming that the registration button of the input device 8 is operated and the registration command is received in the period in which the line-of-sight does not move (step S 105).

The check unit 30 executes a process of determining whether the image extracted by the extraction unit 28 can be confirmed as the registration information. That is, the check unit 30 determines whether a confirmation command has been received from the input device 8 (step S106). When the cancel command is output from the input device 8, or when neither the confirmation command nor the cancel command is output from the input device 8 in the confirmation period, the information registration device 3 repeats the operations in and after step S101.

In a case where receiving the confirmation command from the input device 8, the registration unit 31 registers the image extracted by the extraction unit 28 as registration information in the database 4 (step S107).

By the operation as described above, the information registration device 3 registers the image of a person or an object to be registered from the monitoring video in the database 4. The order of steps in FIG. 6 is an example, and the operation order of the information registration device 3 is not limited to the example of FIG. 6.

In the information registration system 1 and the information registration device 3 of the first example embodiment, the position of a person or an object to be registered in the monitoring video can be acquired only by the surveillance staff member (registered operator) 7 looking at the person or the object to be registered in the monitoring video instead of operating the input device 8. That is, the time required for the operation of designating the person or the object to be registered in the monitoring video is shortened as compared with the case where the surveillance staff member 7 operates and executes the input device 8. Therefore, the information registration system 1 and the information registration device 3 according to the first example embodiment can reduce the operation time for the registered operator to designate, for registration, the partial region in which the person to be registered appears in the captured image.

Further, in the first example embodiment, the information registration device 3 extracts the image of a person or an object to be registered from a captured image (monitoring video) not only by the movement of the line-of-sight in which the line-of-sight has not moved but also in a state where a condition that a registration command has been received from the input device 8 is satisfied. Therefore, the information registration device 3 can prevent the following erroneous registration of an image. For example, in a case where the surveillance staff member 7 stops moving the line-of-sight even though the surveillance staff member 7 does not intend to register the image, it is assumed that the registration command is not output from the input device 8. In such a case, since the image is not extracted from the monitoring video based on the line-of-sight by the information registration device 3, a situation in which the image is registered against the will of the surveillance staff member 7 is prevented.

### Second Example Embodiment

Hereinafter, the second example embodiment according to the present invention will be described. In the description of the second example embodiment, the same reference numerals are given to the same name parts as the components constituting the information registration system 1 and the information registration device 3 of the first example embodiment, and redundant description of the common parts will be omitted.

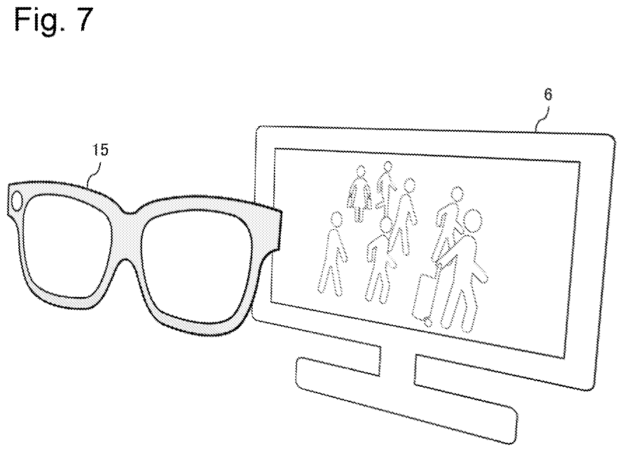

In the first example embodiment, the imaging device 5 is used as a line-of-sight information providing device that detects the line-of-sight of the surveillance staff member 7. Instead of this, in the second example embodiment, glasses 15 with a line-of-sight detection function as illustrated in FIG. 7 are used as the line-of-sight information providing device. That is, the information registration system 1 of the second example embodiment includes the eyeglasses 15 with a line-of-sight detection function in addition to the imaging device 2, the information registration device 3, the database 4, the imaging device 5, the display device 6, and the input device 8. In the second example embodiment, the imaging device 5 does not function as a line-of-sight information providing device, but captures a face image of the surveillance staff member 7 in order to perform authentication for determining whether information registration is permitted.

The eyeglasses 15 with a line-of-sight detection function are eyeglasses having a function of detecting the line-of-sight of the wearer. A camera (not illustrated) is attached to the eyeglasses 15 with a line-of-sight detection function. This camera captures an image of a display screen of the display device 6 viewed by a person (here, the surveillance staff member 7) wearing the glasses 15 with a line-of-sight detection function. A partial region of the display screen of the display device 6 located ahead of the line-of-sight of the surveillance staff member 7 can be detected based on the image captured by the camera and the information of the line-of-sight detected by the eyeglasses 15 with a line-of-sight detection function.

In the second example embodiment, since the glasses 15 with a line-of-sight detection function instead of the imaging device 5 are used as a line-of-sight information providing device, the line-of-sight detection unit 27 of the information registration device 3 detects the line-of-sight of the surveillance staff member 7 using the information about the line-of-sight detected by the glasses 15 with a line-of-sight detection function. The line-of-sight detection unit 27 detects that the detected line-of-sight has not moved for the attention time by using the information about the line-of-sight detected by the eyeglasses 15 with a line-of-sight detection function.

Configurations of the information registration system 1 and the information registration device 3 in the second example embodiment other than the above are similar to those in the first example embodiment, and the description thereof will be omitted here.

The information registration system 1 according to the second example embodiment uses information about the line-of-sight of the eyeglasses 15 with a line-of-sight detection function. With such a configuration, the information registration system 1 and the information registration device 3 according to the second example embodiment can achieve effects similar to those of the first example embodiment.

### Third Example Embodiment

Hereinafter, the third example embodiment according to the present invention will be described. In the description of the third example embodiment, the same reference numerals are given to the same name parts as the components constituting the information registration system and the information registration device of the first example embodiment, and redundant description of the common parts will be omitted.

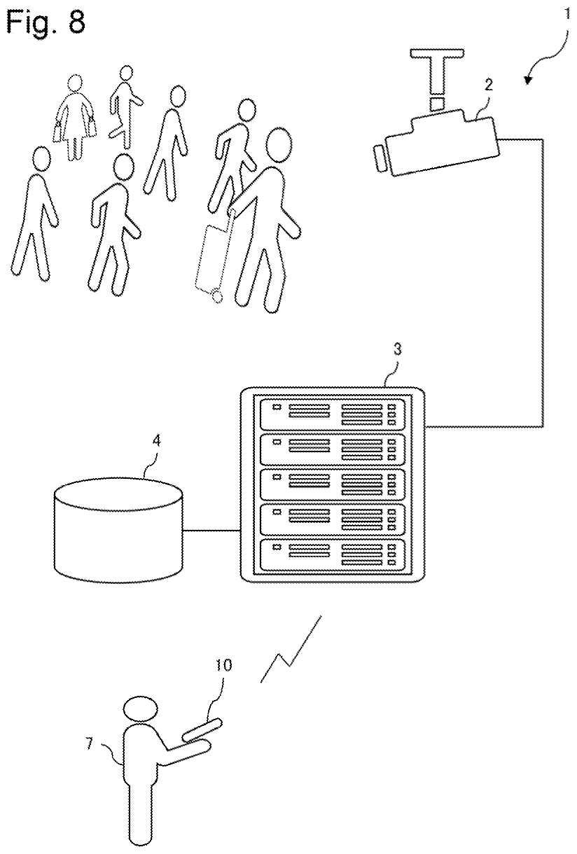

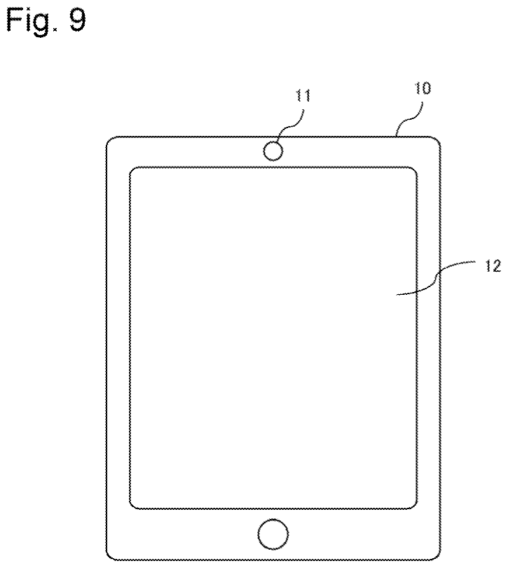

FIG. 8 is a diagram illustrating a configuration of an information registration system 1 according to the third example embodiment. The information registration system 1 of the third example embodiment includes a mobile terminal 10 instead of the imaging device 5, the display device 6, and the input device 8 constituting the information registration system 1 of the first example embodiment. The mobile terminal 10 is assumed to be possessed by the surveillance staff member 7 who is a registered operator, and includes an imaging device 11 and a display device 12 as illustrated in FIG. 9 in addition to an arithmetic device that executes information processing. The mobile terminal 10 also has a function as an input device. There are various aspects that the mobile terminal 10 as an input device that can have, and the description thereof will be omitted here because it is not limited.

As in the imaging device 5 in the first example embodiment, the imaging device 11 has a function of capturing the image of the face of the surveillance staff member 7 who is a registered operator. The image captured by the imaging device 11 is used for authentication of the surveillance staff member 7 by the authentication unit 25 of the information registration device 3 (determination as to whether information registration is permitted) and detection of the line-of-sight of the surveillance staff member 7. That is, the imaging device 11 functions as a line-of-sight information providing device.

The display device 12 functions as in the display device 6 in the first example embodiment. That is, when the mobile terminal 10 receives the monitoring video by the imaging device 2 via the information registration device 3, the monitoring video is displayed on the display device 12 by the control operation of the control display unit (not illustrated) provided in the mobile terminal 10.

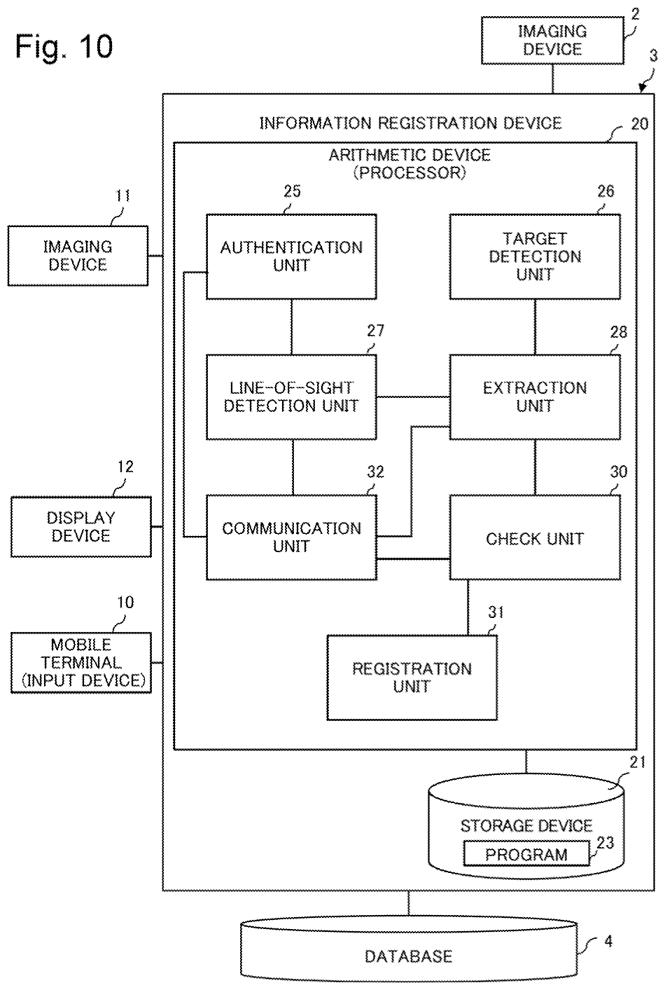

FIG. 10 is a block diagram illustrating a functional configuration of the information registration device 3 according to the third example embodiment. In the third example embodiment, the information registration device 3 includes a communication unit 32. The communication unit 32 has a function of executing a process related to communication in order to communicate information such as a monitoring video of the imaging device 2 and a captured image and data of the imaging device 11 between the information registration device 3 and the mobile terminal 10.

In the third example embodiment, the authentication unit 25 uses the face image captured by the imaging device 11 of the mobile terminal 10 to determine whether the person (that is, the surveillance staff member 7) appearing in the image captured by the imaging device 11 is a person who is permitted to register information as in the first example embodiment.

The line-of-sight detection unit 27 detects a line-of-sight of a person (that is, the surveillance staff member 7) appearing in an image captured by imaging device 11. The extraction unit 28 extracts an image of a partial region of the monitoring video ahead of the line-of-sight of the surveillance staff member 7 by using information about the positional relationship between the lens of the imaging device 11 and the display screen of the display device 12 given in advance and information about the line-of-sight of the surveillance staff member 7 by the line-of-sight detection unit 27.

Configurations of the information registration system 1 and the information registration device 3 in the third example embodiment other than the above are similar to those in the first example embodiment, and the description thereof will be omitted here.

In the information registration system 1 according to the third example embodiment, the mobile terminal 10 possessed by the surveillance staff member 7 has functions similar to the functions of the imaging device 5, the display device 6, and the input device 8 described in the first example embodiment. The information registration system 1 and the information registration device 3 according to the third example embodiment having such a configuration can also achieve effects similar to those of the first example embodiment.

### Fourth Example Embodiment

Hereinafter, the fourth example embodiment according to the present invention will be described.

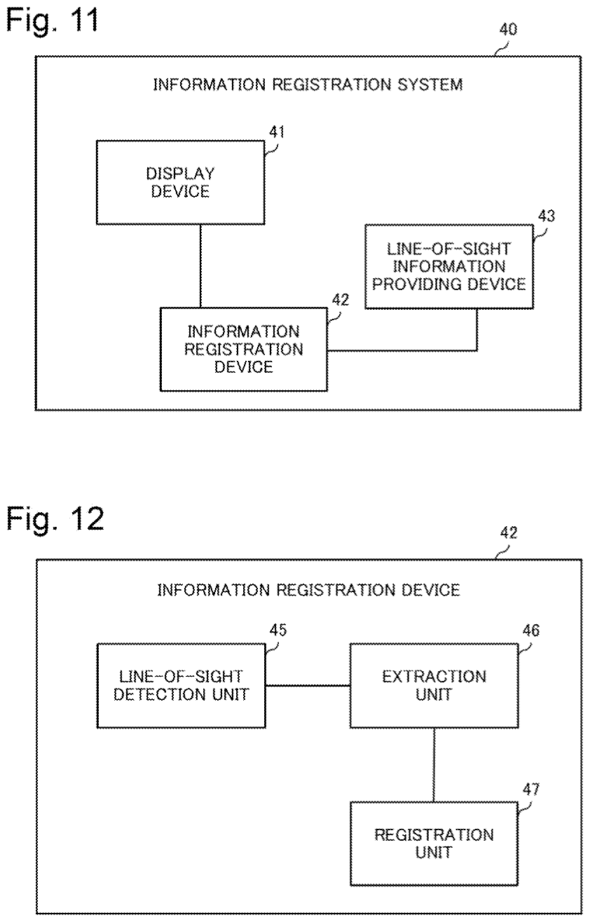

FIG. 11 is a block diagram schematically illustrating a configuration of an information registration system according to the fourth example embodiment. FIG. 12 is a block diagram illustrating a functional configuration of an information registration device constituting an information registration system according to the fourth example embodiment.

An information registration system 40 according to the fourth example embodiment includes a display device 41, an information registration device 42, and a line-of-sight information providing device 43, and is configured to register an image of a person or an object appearing in the display device 41. That is, the display device 41 has a function of displaying images, characters, and the like, and displays here a captured image in which a person or an object to be possibly registered is captured.

The line-of-sight information providing device 43 is a device that provides the information registration device 42 with information for detecting the line-of-sight of the registered operator who is a person viewing the captured image displayed on the display device 41. For example, an imaging device that captures at least eye of the registered operator functions as the line-of-sight information providing device 43.

The information registration device 42 has a function of detecting a person or an object to be registered from the captured image displayed on the display device 41 using the line-of-sight of the registered operator, and registering the detected image to be registered in the storage device. That is, the information registration device 42 is, for example, a computer device, and includes a line-of-sight detection unit 45, an extraction unit 46, and a registration unit 47 as function units implemented by, for example, a processor.

The line-of-sight detection unit 45 has a function of detecting the line-of-sight of the registered operator viewing the captured image appearing in the display device 41.

The extraction unit 46 has a function of extracting an image of a person or an object appearing in a partial region of the captured image ahead of the line-of-sight of the registered operator when the detected line-of-sight of the registered operator does not move for a preset attention time.

The registration unit 47 has a function of registering the extracted image in a predetermined storage device.

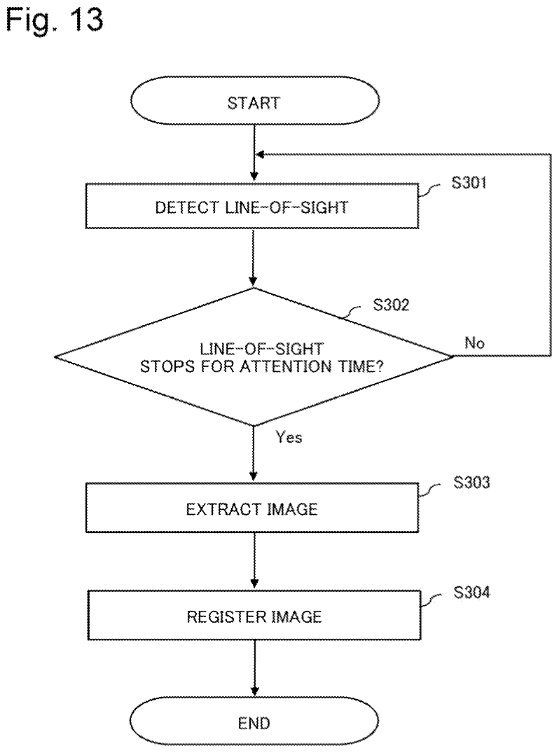

FIG. 13 is a flowchart illustrating an operation example related to information registration in the information registration device 42. Next, an operation example related to information registration in the information registration device 42 will be described with reference to FIG. 13. For example, the line-of-sight detection unit 45 detects the line-of-sight of the registered operator viewing the captured image appearing in the display device 41 (step S301), and determines whether the detected line-of-sight does not move over the attention time (step S302). In a case where the line-of-sight moves before the attention time elapses, the line-of-sight detection unit 45 repeats the operations in and after step S301 (that is, the line-of-sight detection operation).

In a case where the detected line-of-sight has not moved for the attention time, the extraction unit 46 extracts an image of a person or an object appearing in a partial region of the captured image ahead of the line-of-sight of the registered operator (step S303). Then, the registration unit 47 registers the extracted image in a predetermined storage device (step S304).

The information registration system 40 and the information registration device 42 according to the fourth example embodiment are configured as described above, and it is possible to shorten the operation time for the registered operator to designate, for registration, a partial region in which a person or an object to be registered appears in the captured image.

The present invention is described above using the above-described example embodiments as exemplary examples. However, the present invention is not limited to the above-described example embodiments. That is, the present invention can have various aspects that can be understood by those skilled in the art within the scope of the present invention.

This application is based upon and claims the benefit of priority from Japanese patent application No. 2020-059322, filed on Mar. 30, 2020, the disclosure of which is incorporated herein in its entirety by reference.

### REFERENCE SIGNS LIST

1, 40 information registration system
2, 5, 11 imaging device
3, 42 information registration device
4 database
6, 12, 41 display device
27, 45 line-of-sight detection unit
28, 46 extraction unit
30 check unit
31 registration unit

What is claimed is:

1. An information registration device comprising:
at least one processor configured to:
detect a line-of-sight of a registered operator who is a person viewing a captured image in which a person or an object to be possibly registered is captured;
extract an image of the person or the object appearing in a partial region of the captured image ahead of the detected line-of-sight in a case where the detected line-of-sight has not moved for a preset attention time; and
register the extracted image in a predetermined storage device.

2. The information registration device according to claim 1, wherein
the at least one processor extracts an image of the person or the object appearing in a partial region of the captured image in a case where the detected line-of-sight does not deviate from a partial region of the captured image for the attention time and a registration command is received.

3. The information registration device according to claim 2, wherein
the registration command is output from an input device possessed by the registered operator.

4. The information registration device according to claim 1, wherein
the at least one processor detects a line-of-sight of the registered operator from a video in which at least eye of the registered operator is captured.

5. The information registration device according to claim 1, wherein
the at least one processor is further configured to execute a process of checking with the registered operator whether the extracted image extracted is confirmed as registration information, wherein
the at least one processor registers the extracted image in the storage device after the extracted image is confirmed as the registration information by the process of checking.

6. An information registration system comprising:
the information registration device according to claim 1;
a display device that displays the captured image in which a person or an object to be possibly registered is captured; and
a line-of-sight information providing device that provides the information registration device with information for detecting a line-of-sight of the registered operator who is a person viewing the captured image.

7. The information registration system according to claim 6, wherein
the line-of-sight information providing device includes an imaging device that images at least eye of the registered operator.

8. An information registration method comprising:
by a computer,
detecting a line-of-sight of a registered operator who is a person viewing a captured image in which a person or an object to be possibly registered is captured;
extracting an image of the person or the object appearing in a partial region of the captured image ahead of the detected line-of-sight in a case where the detected line-of-sight has not moved for a preset attention time; and
registering the extracted image in a predetermined storage device.

9. A non-transitory program storage medium storing a computer program for causing a computer to execute:
detecting a line-of-sight of a registered operator who is a person viewing a captured image in which a person or an object to be possibly registered is captured;
extracting an image of the person or the object appearing in a partial region of the captured image ahead of the detected line-of-sight in a case where the detected line-of-sight has not moved for a preset attention time; and
registering the extracted image in a predetermined storage device.
